(19) United States
(12) Patent Application Publication
(10) Pub. No.: US 2026/0304224 A1
(43) Pub. Date: Oct. 1, 2026

(54) FLEXIBLE GAP REPORT INITIATION FOR PACKET DATA CONVERGENCE PROTOCOL (PDCP)

(71) Applicant: QUALCOMM Incorporated, San Diego, CA (US)

(72) Inventors: Sitaramanjaneyulu Kanamarlapudi, San Diego, CA (US); Linhai He, San Diego, CA (US)

(21) Appl. No.: 19/631,818

(22) Filed: Mar. 27, 2026

Related U.S. Application Data
(60) Provisional application No. 63/778,957, filed on Mar. 27, 2025.

(51) Int. Cl. H04W 28/06; H04L 5/00; H04L 47/32; H04L 47/56; H04W 24/10

(52) U.S. Cl. CPC H04W 28/06; H04L 5/0055; H04L 47/32; H04L 47/56; H04W 24/10

(57) ABSTRACT

Certain aspects provide techniques for flexible gap reporting in a packet data convergence protocol (PDCP). A method includes determining that at least one sequence number (SN) of a PDCP transmission satisfies at least one trigger condition and transmitting a PDCP gap report. The at least one trigger condition comprises determining that a PDCP status report requesting retransmission of the at least one SN has been received after the at least one SN has been discarded, determining that an acknowledgment for the at least one SN has been received and that the at least one SN has been discarded due to packet loss on a network interface, determining that the at least one SN has been discarded due to one or more operational constraints, or determining that the at least one SN has been discarded due to exceeding a delay budget associated with scheduling by a Radio Link Control (RLC) entity.

### CROSS-REFERENCE TO RELATED APPLICATIONS

This application claims the benefit of U.S. Provisional Application No. 63/778,957, entitled, “FLEXIBLE GAP REPORT INITIATION FOR PACKET DATA CONVERGENCE PROTOCOL (PDCP),” filed on Mar. 27, 2025, which is expressly incorporated by reference herein in its entirety.

### BACKGROUND

### Field of the Disclosure

Aspects of the present disclosure relate to wireless communications, and more particularly, to techniques for gap reporting for packet data convergence protocol transmission.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

The present techniques provide a flexible procedure for Packet Data Convergence Protocol (PDCP) Sequence Number (SN) gap reporting in 5G networks. Rather than limiting PDCP SN Gap Report initiation to a single event, these techniques define a PDCP SN Gap Report initiation procedure that may be triggered by various conditions, including receiving a PDCP status report requesting retransmission of already-discarded SNs, detecting that an acknowledgment has been received by a lower layer entity but the corresponding SDU has been lost on a network interface between network entities, determining that an SN has been discarded due to operational constraints such as memory overflow, packet prioritization, congestion handling, machine learning inferences, or combinations thereof, or determining that an SN has been discarded due to scheduling delays at a Radio Link Control (RLC) entity. By enabling the transmitter to initiate a PDCP SN Gap Report under these various trigger conditions, these techniques may maintain synchronization between transmitter and receiver PDCP entities, potentially preventing or reducing unnecessary delays associated with the t-Reordering Timer and improving data transmission efficiency, especially for latency-sensitive applications.

One aspect provides a system that includes a processor and a memory storing instructions which, when executed by the processor, cause the processor to: determine that at least one sequence number (SN) of a packet data convergence protocol (PDCP) transmission has been discarded and that at least one trigger condition associated with the discarded at least one SN is satisfied; and transmit a PDCP gap report based on the at least one SN satisfying the at least one trigger condition.

Another aspect provides a method that includes determining that at least one sequence number (SN) of a packet data convergence protocol (PDCP) transmission has been discarded and that at least one trigger condition associated with the discarded SN is satisfied, and transmitting a PDCP gap report based on the at least one SN satisfying the at least one trigger condition. In some examples, the at least one trigger condition comprises at least one of: receiving a PDCP status report requesting retransmission of the at least one SN after the at least one SN has been discarded, determining that an acknowledgment for the at least one SN has been received by a lower layer entity and that the at least one SN has been discarded due to packet loss on a network interface between network entities, determining that the at least one SN has been discarded due to one or more operational constraints comprising at least one of memory overflow, packet prioritization, congestion handling, or machine learning inferences, or determining that the at least one SN has been discarded due to exceeding a delay budget associated with scheduling by a Radio Link Control (RLC) entity.

Other aspects provide: an apparatus operable, configured, or otherwise adapted to perform any one or more of the aforementioned methods and/or those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts a process flow for communications in a network with PDCP gap reporting.

FIG. 6 depicts a method for wireless communications.

FIG. 7 depicts aspects of an example communications device.

### DETAILED DESCRIPTION

Aspects of the present disclosure provide apparatuses, methods, processing systems, and computer-readable mediums for gap reporting for PDCP transmissions.

In 5G New Radio (NR) networks, the Packet Data Convergence Protocol (PDCP) layer manages functions such as header compression, encryption, integrity protection, and sequence numbering of data packets. Each PDCP Service Data Unit (SDU) is assigned a unique Sequence Number (SN) to ensure correct ordering at the receiver. The PDCP COUNT, combining the SN and Hyper Frame Number (HFN), is used for ciphering and data integrity. The PDCP layer operates above the Radio Link Control (RLC) layer and below the Service Data Adaptation Protocol (SDAP) layer in the 5G NR protocol stack. For data radio bearers (DRBs), the PDCP entity may be configured to operate with either RLC Acknowledged Mode (AM) or RLC Unacknowledged Mode (UM). In RLC AM, the RLC layer provides reliable delivery through retransmissions, and the PDCP layer supports lossless handover through mechanisms such as PDCP re-establishment, PDCP data recovery, and PDCP status reporting. In RLC UM, the RLC layer does not guarantee delivery, and the PDCP COUNT is reset upon PDCP re-establishment.

Under certain conditions, the transmitter may discard PDCP SDUs. Reasons for discarding may include exceeding delay budgets (e.g., expiry of a discardTimer or discardTimerForLowImportance), implementation-specific constraints like memory overflow or packet prioritization, or challenging network conditions. When PDCP SDUs are discarded, gaps may occur in the sequence of PDCP SNs received by the receiver. Specifically, when the receiver receives PDCP SDUs with COUNT values higher than a missing (discarded) SDU, the receiver may activate the t-Reordering timer. The t-Reordering timer is a reordering mechanism that delays delivery of successfully received PDCP SDUs to upper layers until the timer expires, in anticipation that the missing SDU may arrive out of order. However, when the missing SDU has been discarded by the transmitter and will never arrive, the t-Reordering timer runs unnecessarily, causing latency in the delivery of subsequent SDUs to upper layers. For latency-sensitive applications such as Extended Reality (XR), even small additional delays introduced by unnecessary t-Reordering timer operation may significantly degrade user experience.

To address the problem of unnecessary t-Reordering timer activation, the PDCP SN Gap Report procedure was introduced (e.g., as defined in 3GPP TS 38.323 Section 5.16). Under this procedure, when the transmitting PDCP entity discards one or more PDCP SDUs and there remain stored SDUs with higher COUNT values, the transmitter compiles and sends a PDCP SN Gap Report to the receiver indicating which SDUs were discarded. The receiver can then advance its receive window without waiting for the discarded SDUs, avoiding unnecessary reordering delays. The PDCP layer also supports related procedures such as PDCP Status Reporting (e.g., 3GPP TS 38.323 Section 5.4), which enables the receiver to request retransmission of missing SDUs, and PDCP Data Recovery (e.g., 3GPP TS 38.323 Section 5.5), which allows the transmitter to retransmit unconfirmed PDUs.

However, there are scenarios where the PDCP SN Gap Report itself may not reach the receiver. For example, during a handover involving a DRB mapped on RLC AM, two problems may arise. First, the source RAN node may have received the gap report from the UE, but existing specifications provide no means to forward this information to the target RAN node. Second, the UE may have transmitted the gap report, but the RLC layer may be flushed by the handover command before the report is successfully delivered, leaving neither the source nor the target RAN node with the gap report information.

In the latter case, after handover completion, the UE retransmits its pending SDUs to the target RAN node as part of PDCP re-establishment. Because the target RAN node has no knowledge that certain SDUs were discarded by the transmitter, it starts the t-Reordering timer unnecessarily, delaying delivery of successfully received SDUs to upper layers until the timer expires.

One approach to this problem is to require the UE to re-submit any unconfirmed PDCP SN Gap Report(s) during PDCP entity re-establishment. However, this addresses only the handover scenario. PDCP SN gaps may also arise from other causes, such as the transmitter receiving a PDCP Status Report requesting retransmission of already-discarded SNs, packet loss on network interfaces between network entities (e.g., between a DU and a CU), scheduling delays at the RLC entity, or implementation-specific reasons such as memory overflow or packet prioritization.

One solution to this problem may be to introduce a flexible PDCP SN gap reporting procedure that defines multiple trigger conditions under which a device sends a PDCP SN Gap Report to the receiver, providing a scalable mechanism for maintaining PDCP entity synchronization across diverse scenarios. The device may monitor for conditions such as re-submission of a previously unconfirmed PDCP SN Gap Report during PDCP entity re-establishment, detecting that a PDCP SDU acknowledged by a lower layer entity has been lost on a network interface between network entities (e.g., between a DU and a CU), discarding PDCP SDUs due to operational constraints such as memory overflow, packet prioritization, or machine learning inferences, receiving a PDCP Status Report requesting retransmission of already-discarded PDCP SNs, or discarding PDCP SDUs due to scheduling delays at the RLC entity.

By proactively sending the PDCP SN Gap Report under these various triggers, the device may ensure that a receiving device of the gap report is promptly informed about discarded PDCP SNs. This may enable the receiver to update its receive window accordingly, avoiding unnecessary activation of the t-Reordering Timer and reducing delays in delivering subsequent PDCP SDUs to upper layers.

In some aspects, the present disclosure provides techniques for flexible PDCP SN gap reporting that may be particularly beneficial in reducing latency in 5G networks. For example, by enabling the transmitter to notify the receiver of discarded PDCP SNs under various conditions, unnecessary t-Reordering delays may be avoided. This may improve data transmission efficiency and enhance the user experience, especially for latency-sensitive applications like Extended Reality (XR).

Additionally, these techniques may improve the functioning of network equipment by maintaining synchronization between PDCP entities across different scenarios and network conditions. By being adaptable to various implementation-specific discarding reasons and future network procedures, the present techniques may provide a robust solution for PDCP synchronization issues, potentially contributing to more reliable and efficient 5G communication systems.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

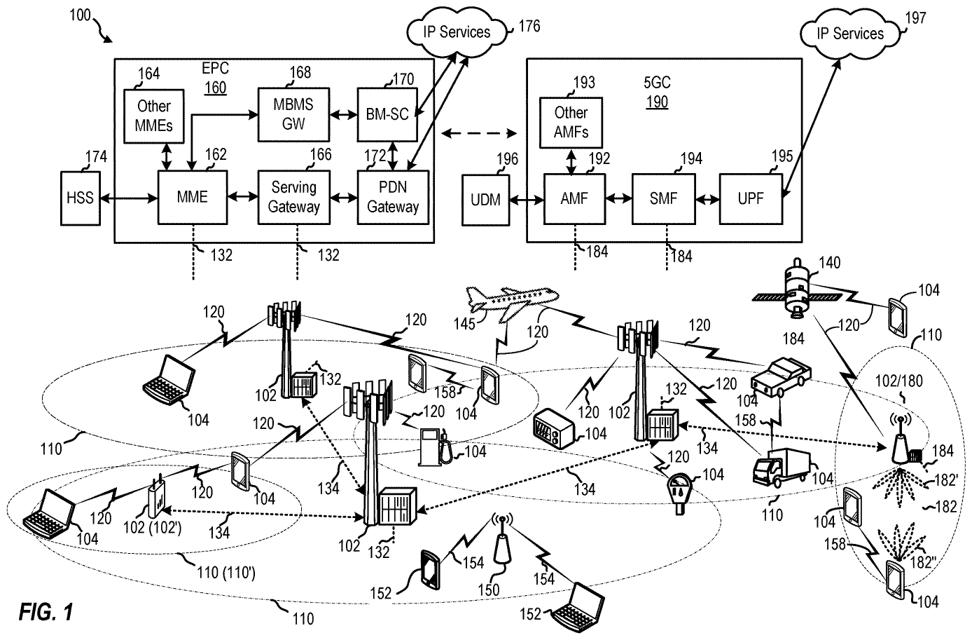

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

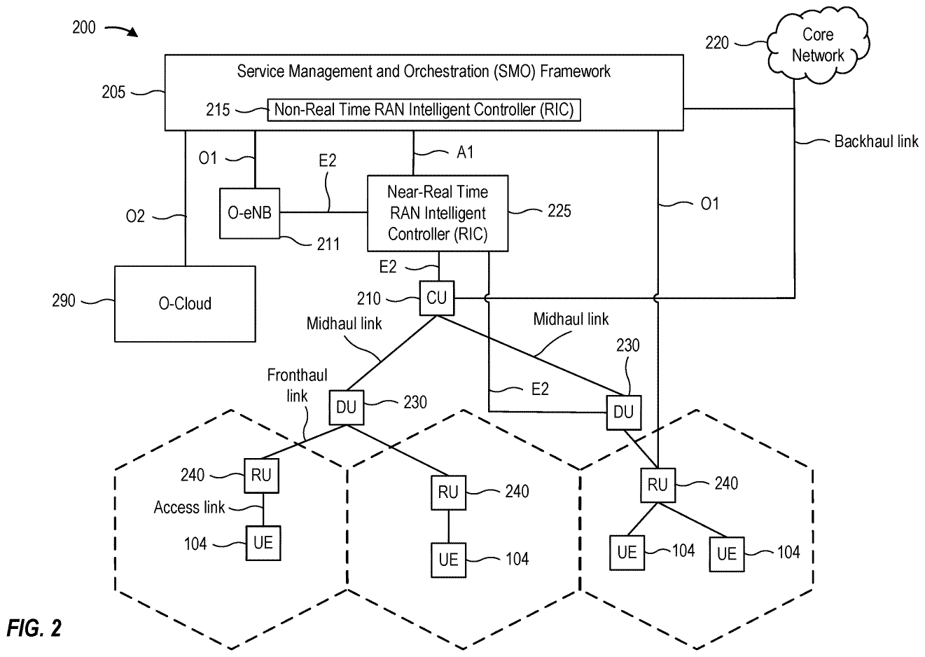

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more, or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182v . BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

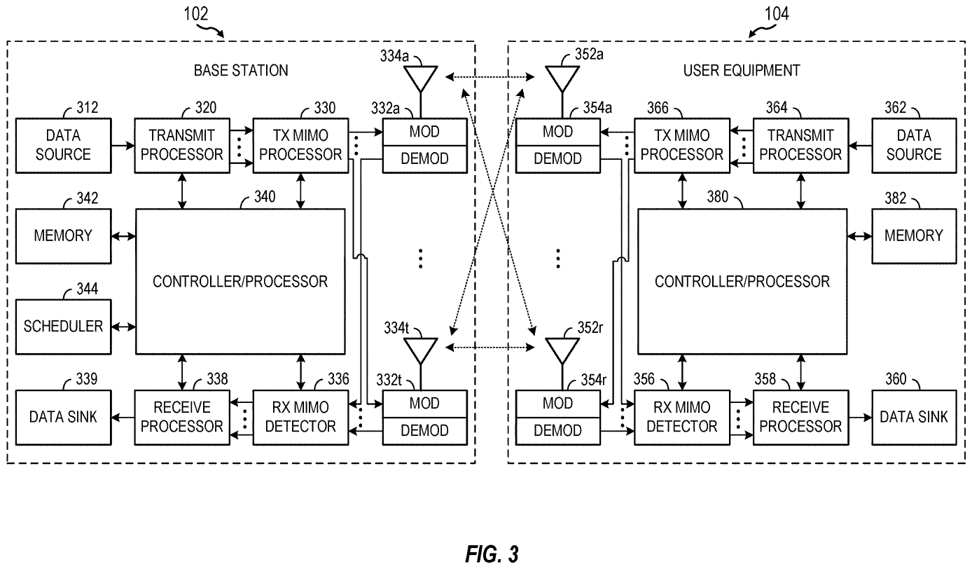

FIG. 3 depicts aspects of an example BS 102 and a UE 104.

Generally, BS 102 includes various processors (e.g., 320, 330, 338, and 340), antennas 334a-t (collectively 334), transceivers 332 a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

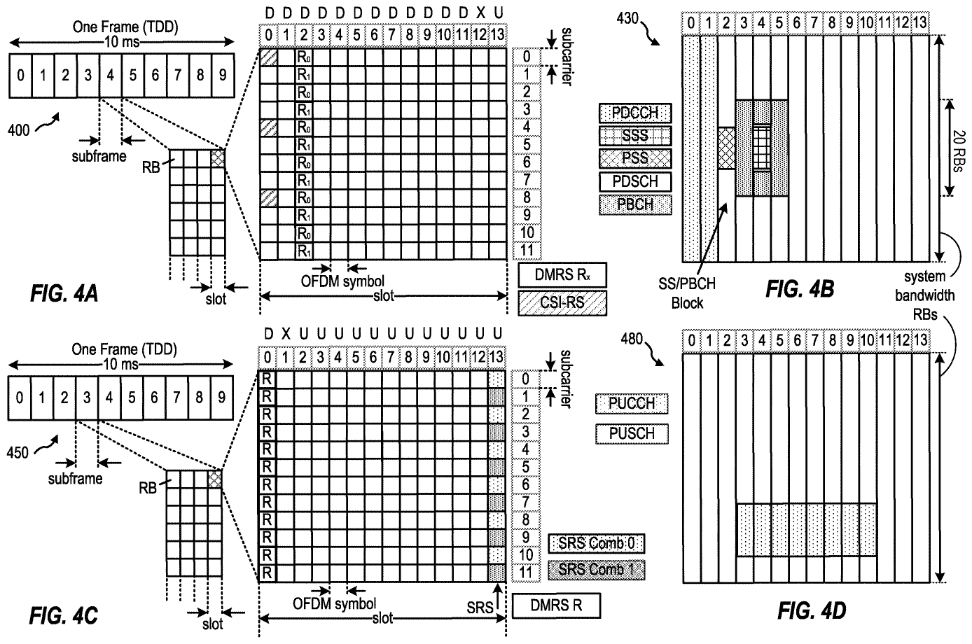

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8slots, respectively, per subframe. Accordingly, for slot configuration 0 and numerology μ, there are 14 symbols/slot and 2μslots/subframe. The subcarrier spacing and symbol length/duration are a function of the numerology. The subcarrier spacing may be equal to 2^{μ}×15 kHz, where μ is the numerology 0 to 6. As such, the numerologyμ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Operations of Entities in a Communications Network

As discussed above, the PDCP layer in 5G NR networks manages header compression, ciphering, integrity protection, and sequence numbering. Each PDCP SDU is associated with a COUNT value used for ordering and security. When the receiving PDCP entity detects a gap in the received sequence (i.e., a missing SDU), it starts a t-Reordering timer that delays delivery of subsequently received SDUs to upper layers. If the missing SDU was discarded by the transmitter and will never arrive, this timer runs unnecessarily, introducing latency.

To mitigate unnecessary t-Reordering timer activation, the PDCP SN Gap Report procedure was introduced (e.g., as defined in 3GPP TS 38.323 Section 5.16). Under this procedure, when the transmitting PDCP entity discards one or more SDUs and there remain stored SDUs with higher COUNT values, the transmitter compiles and sends a PDCP SN Gap Report to the receiver. The gap report identifies the discarded SDUs using a first discarded COUNT (FDC) field and, optionally, a discard bitmap. Upon receiving the gap report, the receiver treats the indicated SDUs as discarded, advances its receive window accordingly, and avoids waiting for SDUs that will never arrive.

The PDCP layer also supports a PDCP Status Report procedure, which enables the receiver to request retransmission of missing SDUs, and a PDCP Data Recovery procedure, which allows the transmitter to retransmit unconfirmed PDUs. These procedures may interact with the PDCP SN Gap Report procedure in important ways. For example, after a handover, the target RAN node's receiving PDCP entity may trigger a PDCP Status Report requesting retransmission of SDUs that the transmitter has already discarded. In such cases, the transmitter cannot fulfill the retransmission request, creating a synchronization gap between the transmitter and receiver PDCP entities that the existing gap report trigger conditions may not address.

To illustrate, consider a handover scenario involving a DRB mapped on RLC AM. The transmitting PDCP entity at the UE discards an SDU and triggers a PDCP SN Gap Report, which is submitted to the RLC layer for transmission. Before the RLC layer can successfully deliver the gap report, the UE receives a handover command that triggers RLC re-establishment, flushing the RLC transmission buffer. As a result, the PDCP SN Gap Report is lost, and neither the source nor the target RAN node has knowledge of the discarded SDU.

After handover completion, the UE retransmits its pending SDUs to the target RAN node as part of PDCP re-establishment. Because the target RAN node has no knowledge that the SDU was discarded, it starts the t-Reordering timer unnecessarily, delaying delivery of successfully received SDUs to upper layers. For latency-sensitive applications such as XR, this unnecessary delay may significantly degrade user experience.

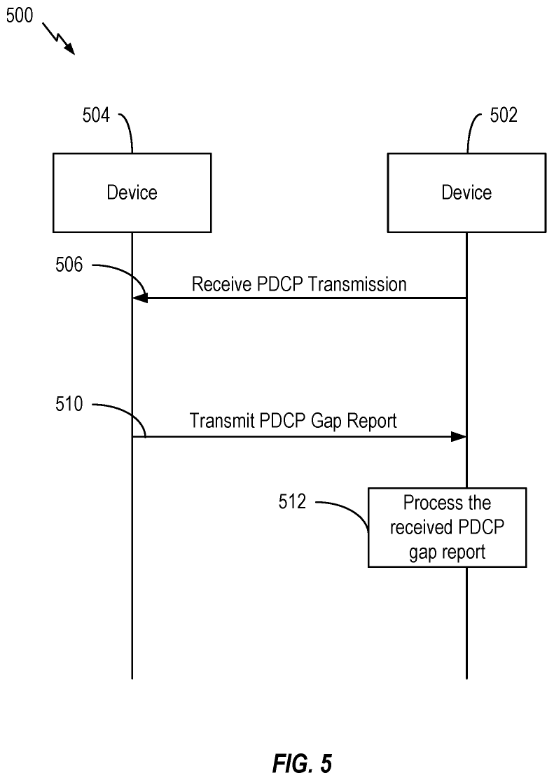

The present techniques address these limitations by defining a flexible PDCP SN Gap Report initiation procedure that can be triggered by various conditions, rather than being limited to a single scenario such as PDCP re-establishment during handover. By defining multiple trigger conditions under which the transmitting PDCP entity initiates a PDCP SN Gap Report, the present techniques provide a flexible and extensible mechanism for maintaining synchronization between transmitter and receiver PDCP entities. In one aspect, the flexible procedure may be triggered when the transmitting PDCP entity receives a PDCP Status Report requesting retransmission of SNs that have already been discarded. Rather than being unable to respond to the retransmission request, the transmitter recognizes the out-of-sync condition and initiates a PDCP SN Gap Report to inform the receiver that the requested SNs were discarded, enabling the receiver to advance its receive window accordingly. In another aspect, the flexible procedure may be triggered when the transmitting PDCP entity detects that a PDCP SDU acknowledged by a lower layer entity has been lost on a network interface between network entities. For example, in a disaggregated base station architecture, the RLC entity at a DU may successfully transmit and acknowledge a PDCP SDU, but the SDU or its delivery confirmation may be lost on the midhaul interface (e.g., F1 interface) between the DU and the CU. The PDCP entity at the CU may detect this inconsistency and initiate a PDCP SN Gap Report to maintain synchronization with the receiver. Similarly, during inter-node procedures such as handover, PDCP status information transferred between source and target RAN nodes via the Xn interface may be lost, leading to out-of-sync conditions that the flexible procedure can address. In yet another aspect, the flexible procedure may be triggered when the transmitting PDCP entity discards SDUs due to operational constraints such as memory overflow, packet prioritization, congestion handling, machine learning inferences, or combinations thereof. For instance, a UE may implement traffic management policies that selectively discard SDUs associated with certain application flows to prioritize other flows under challenging grant conditions, or may employ machine learning models to predict which SDUs are likely to experience excessive delays and proactively discard them. In each case, the flexible procedure enables the transmitter to notify the receiver of the discards. In a further aspect, the flexible procedure may be triggered when the transmitting PDCP entity discards SDUs due to scheduling delays at the RLC entity, such as when cumulative retransmission delays or resource contention cause SDUs to exceed their delay budgets. In still another aspect, the flexible procedure may be triggered during PDCP entity re-establishment, where the transmitting PDCP entity re-submits any previously transmitted PDCP SN Gap Report(s) for which successful delivery has not been confirmed by lower layers. This ensures that gap report information is preserved across mobility events such as handovers. This flexible approach ensures that the PDCP SN Gap Report procedure is not limited to any single scenario but can adapt to diverse operational conditions, including those that may arise in future network deployments and protocol evolutions. The following description with respect to FIGS. 5-7 provides further details regarding the flexible PDCP SN Gap Report initiation procedure and the various trigger conditions.

FIG. 5 depicts a process flow 500 for communications in a network between a second device 502 and a first device 504. In some aspects, the second device 502 may be an example of the BS 102 depicted and described with respect to FIGS. 1 and 3, or a disaggregated base station depicted and described with respect to FIG. 2. Similarly, the first device 504 may be an example of the UE 104 depicted and described with respect to FIGS. 1 and 3. In further aspects, the first device 504 may be an example of the BS 102 depicted and described with respect to FIGS. 1 and 3, or a disaggregated base station depicted and described with respect to FIG. 2. Similarly, the second device 502 may be an example of the UE 104 depicted and described with respect to FIGS. 1 and 3. In some examples, the first device 504 may comprise a transmitter located in at least one of a user equipment (UE), a network node, or a combination thereof. The process flow 500 illustrates the flexible PDCP SN Gap Report initiation procedure, in which the first device 504 monitors for various trigger conditions and transmits a PDCP SN Gap Report to the second device 502 when one or more of the trigger conditions are satisfied, thereby enabling the second device 502 to update its receive window and avoid unnecessary t-Reordering delays.

At step 506, the first device 504 may receive a packet data convergence protocol (PDCP) transmission, such as a PDCP transmission transmitted by the second device 502. The PDCP is a protocol layer in the 5G NR stack responsible for functions such as header compression, encryption, integrity protection, and sequence numbering of data packets between network entities. The PDCP transmission may include PDCP service data units (SDUs) associated with corresponding sequence numbers (SNs), received from the second device 502. In certain implementations, the PDCP transmission may consist of multiple PDCP SDUs, each assigned a unique SN for proper sequencing at the receiver. For example, the PDCP transmission may include PDCP SDUs with SNs 1, 2, 3, 4, and 5. The PDCP transmission may be associated with a data radio bearer (DRB) configured to operate with RLC Acknowledged Mode (AM) or RLC Unacknowledged Mode (UM). In certain implementations, the DRB may be configured by upper layers to send a PDCP SN Gap Report in the uplink (e.g., via an sn-GapReport configuration parameter). The first device 504 may maintain PDCP state variables including TX_NEXT (the COUNT value of the next PDCP SDU to be transmitted) and may track which PDCP SDUs have been successfully delivered to lower layers and which have been discarded.

The first device 504 may monitor the received PDCP transmissions to identify any SNs that meet specified trigger conditions. In certain implementations, the first device 504 may determine that at least one sequence number (SN) of the packet data convergence protocol (PDCP) transmission satisfies at least one trigger condition.

In certain implementations, determining that the at least one SN satisfies the at least one trigger condition may include determining that the at least one SN has been discarded. The first device 504 may discard SNs for various reasons, such as exceeding delay budgets, operational constraints, or due to packet loss on network interfaces. In one implementation, the trigger condition may be satisfied if an SN has been discarded, such as according to one or more of the examples discussed below. In another implementation, the trigger condition may not be satisfied if an SN has not been discarded.

As one example, the first device 504 may receive a PDCP status report requesting retransmission of the at least one SN. This PDCP status report may be sent by the second device 502 (e.g., as part of a PDCP entity re-establishment or PDCP data recovery procedure) and may request retransmission of specific SNs that the first device 504 has already discarded. For instance, after a handover, the target RAN node's receiving PDCP entity may trigger a PDCP Status Report indicating certain SNs as missing and requesting their retransmission. However, the transmitting PDCP entity at the first device 504 may have already discarded those SNs (e.g., due to expiry of the discardTimer prior to the handover). The first device 504 may identify that the requested SNs have been discarded and thus determine that the trigger condition is satisfied. The first device 504 may accordingly recognize out-of-sync conditions between the first device 504 and the second device 502 due to lost or discarded SNs. This trigger condition addresses scenarios where the PDCP SN Gap Report was either never generated (e.g., because the discard occurred before the gap report procedure was configured) or was generated but lost during a mobility event (e.g., due to RLC re-establishment flushing the transmission buffer). In one implementation, the trigger condition may be satisfied if the first device 504 received a PDCP status report requesting retransmission of an SN and the SN has been discarded. In another implementation, the trigger condition may not be satisfied if the first device 504 received a PDCP status report requesting retransmission of an SN and the SN has not been discarded.

As another example, determining that the at least one SN satisfies the at least one trigger condition may involve determining that an acknowledgment for the at least one SN has been received by a lower layer entity but has been lost on a network interface between network entities. In a disaggregated base station architecture, the PDCP entity may be hosted at a Central Unit (CU) while the RLC entity is hosted at a Distributed Unit (DU). The RLC entity at the DU may successfully receive and acknowledge a PDCP SDU, but the acknowledgment or the SDU itself may be lost on the midhaul interface (e.g., F1 interface) between the DU and the CU. In such cases, the CU's PDCP entity may not receive confirmation of successful delivery, even though the RLC layer has acknowledged the SDU. This may result in the PDCP entity at the CU treating the SDU as undelivered, while the receiver's PDCP entity (e.g., at the UE) never receives the SDU. Similarly, during control plane procedures that result in PDCP node relocation from a source RAN node to a target RAN node, PDCP status information (e.g., SN Status Transfer) may be lost or may not accurately reflect the delivery status of all SDUs, leading to out-of-sync conditions between the transmitter and receiver PDCP entities. The first device 504 may monitor acknowledgments from intermediate network entities and, if an acknowledgment for a particular SN is received by a lower layer but the corresponding SDU is determined to have been lost on the network interface, the first device 504 may determine that the SN has been effectively discarded and that the trigger condition is satisfied. In one implementation, the trigger condition may be satisfied if an acknowledgment for the at least one SN has been received by a lower layer entity but the SDU has been lost on a network interface between network entities. In one implementation, the trigger condition may not be satisfied if the SDU has been successfully delivered across all network interfaces.

In some implementations, the first device 504 may determine that the at least one SN has been discarded due to exceeding a delay budget associated with scheduling by a Radio Link Control (RLC) entity. The RLC entity within the first device 504 may have delay budgets assigned for transmitting PDCP SDUs. These delay budgets may be related to the discardTimer configured for the DRB, quality of service (QoS) parameters such as the Packet Delay Budget (PDB), or implementation-specific scheduling constraints. If the transmission of an SN exceeds the allocated delay budget, the RLC entity may discard the SN. For example, in challenging radio conditions with high block error rates (BLER), the RLC entity may require multiple retransmission attempts to successfully deliver a PDU. If the cumulative delay from these retransmission attempts exceeds the delay budget, the PDCP entity may discard the corresponding SDU. In another example, the RLC entity may experience scheduling delays due to resource contention, grant limitations, or prioritization of other bearers, causing certain SDUs to exceed their delay budgets. The first device 504 may monitor the scheduling delays and identify discarded SNs as a result of exceeded delay budgets. In one implementation, the trigger condition may be satisfied if the at least one SN has been discarded due to exceeding a delay budget associated with scheduling by an RLC entity. In another implementation, the trigger condition may not be satisfied if the at least one SN has not been discarded due to exceeding a delay budget associated with scheduling by an RLC entity.

In other implementations, determining that the at least one SN has been discarded may include identifying that the SN has been discarded due to one or more operational constraints. These operational constraints may include memory overflow, computational resource constraints, packet prioritization, proprietary procedures, machine learning inferences, or a combination thereof. For instance, the first device 504 may experience limited memory resources, necessitating the discarding of older or lower-priority SNs to accommodate new data. Memory overflow may occur when the buffer capacity of the PDCP entity or the RLC entity is insufficient to store incoming PDCP SDUs, prompting the device to discard certain SNs to prevent buffer exhaustion and maintain operational stability. In another example, the first device 504 may experience computational resource constraints, such as insufficient processing capacity (e.g., limited processing cycles or MIPS availability), that prevent timely processing of all incoming PDCP SDUs, prompting the device to discard certain SNs to maintain real-time processing requirements. In another example, the first device 504 may implement packet prioritization strategies based on factors like flow identification, QoS parameters, or traffic characteristics. The device may prioritize certain SNs over others based on the associated QoS flow identifier (QFI), the 5G QoS Indicator (5QI), or application-layer priorities. For instance, in applications such as video conferencing or XR, the device may prioritize I-frames over P-frames or B-frames, leading to the discarding of less critical SNs to maintain service quality for higher-priority data flows. In yet another example, the device may implement flow-based packet flush procedures, where all SDUs associated with a particular flow or bearer are discarded in response to changing network conditions or application requirements. In one implementation, the trigger condition may be satisfied if the at least one SN has been discarded due to one or more operational constraints. In another implementation, the trigger condition may not be satisfied if the at least one SN has not been discarded due to one or more operational constraints.

Proprietary procedures, such as procedures specific to particular UEs or network entities, may also lead to the discarding of specific SNs. For example, the first device 504 may utilize custom traffic management processes or policies that result in the selective discarding of SNs to optimize network performance according to proprietary criteria. In one example, a UE may implement a modem-level traffic management policy that selectively discards PDCP SDUs associated with certain application flows to prioritize other flows under challenging grant conditions (e.g., when uplink grants are insufficient to transmit all pending data). In another example, a network entity may implement vendor-specific optimization algorithms that discard SDUs based on predicted network congestion or anticipated handover events. Additionally or alternatively, the first device 504 may employ machine learning models to predict network conditions or user behavior, proactively deciding which SNs to discard. For example, the device 504 may use a trained model to predict that certain SNs are likely to experience excessive delays or transmission failures based on current channel conditions, mobility patterns, or traffic load, and may choose to discard them in advance to improve overall transmission efficiency and reduce latency for remaining SDUs. In each of these cases, the discarding of SNs by the transmitter creates a gap in the PDCP SN sequence at the receiver, and the generic PDCP SN Gap Report procedure enables the transmitter to proactively notify the receiver of these discards regardless of the specific reason for discarding.

Furthermore, the first device 504 may determine that the at least one SN has been discarded due to packet loss on a network interface between network entities, and that an acknowledgment for the at least one SN has been received by a lower layer entity. Packet loss may occur on interfaces such as the F1 interface between Distributed Units (DUs) and Central Units (CUs), the Xn interface between different RAN nodes, or the E1 interface between CU-CP and CU-UP entities. In a disaggregated base station architecture, the PDCP entity at the CU may submit a PDCP SDU to the RLC entity at the DU for transmission. The RLC entity may successfully transmit the SDU over the air interface and receive an acknowledgment from the receiver. However, the acknowledgment or the delivery confirmation may be lost on the F1 midhaul interface between the DU and the CU, causing the CU's PDCP entity to be unaware that the SDU was successfully delivered. Additionally, packet loss may occur on New Radio Unlicensed (NR-U) links, where the use of unlicensed spectrum introduces additional sources of transmission failure such as Listen-Before-Talk (LBT) failures, channel occupancy by other radio access technologies, or regulatory duty cycle limitations. In NR-U deployments, the RLC entity may receive an acknowledgment indicating successful transmission, but the corresponding PDCP SDU may have been lost due to an LBT failure or channel access contention on the unlicensed link, resulting in the PDCP entity discarding the SDU while the receiver never receives it. Furthermore, during inter-node procedures such as handover or dual connectivity configuration changes, PDCP status information transferred between source and target RAN nodes via the Xn interface may be lost or corrupted, leading to inconsistencies between the transmitter and receiver PDCP entities. The device 504 may detect packet loss by monitoring error rates, utilizing network diagnostics, or detecting inconsistencies between lower layer acknowledgments and PDCP-level delivery confirmations. The device 504 may consequently determine that the SNs affected by the packet loss satisfy the trigger condition and initiate a PDCP SN Gap Report to restore synchronization with the receiver.

At step 510, based on the at least one SN satisfying the at least one trigger condition, the first device 504 may transmit a PDCP gap report to the second device 502. In other instances, if the at least one SN does not satisfy the at least one trigger condition, the first device 504 may not transmit a PDCP gap report to the second device 502. In certain implementations, the PDCP gap report may be structured in accordance with one or more relevant standards, such as 3GPP TS 38.323 Section 6.2.3.5. In certain implementations, the PDCP gap report may include an indication of the at least one SN that has been discarded. In some implementations, the first device 504 may transmit the PDCP gap report as part of a PDCP entity re-establishment procedure. For example, when upper layers request PDCP entity re-establishment (e.g., during a handover), the transmitting PDCP entity may determine whether any previously transmitted PDCP SN Gap Report(s) have not been confirmed as successfully delivered by lower layers. If such unconfirmed PDCP SN Gap Report(s) exist, the transmitting PDCP entity may re-submit the PDCP SN Gap Report(s) to lower layers as part of the re-establishment procedure, ensuring that the target RAN node receives the gap report information. In other implementations, the first device 504 may transmit the PDCP gap report independently of any re-establishment procedure, based on detecting one or more of the trigger conditions described above. The generic nature of the trigger conditions enables the first device 504 to initiate PDCP SN Gap Reports in response to diverse scenarios, including scenarios that may not involve any mobility event or re-establishment procedure.

In certain implementations, determining the PDCP gap report may include setting a first discarded COUNT (FDC) field to the smallest value of the discarded SNs. The FDC field allows the second device 502 to identify the starting point of the sequence numbers that have been discarded. For example, if the first device 504 has discarded SNs 3 and 4 within a sequence of SNs from 1 to 6, the FDC field may be set to ‘3’, indicating that discarding starts from SN 3.

In additional or alternative implementations, the PDCP gap report may include a discard bitmap indicating the at least one SN. The discard bitmap may represent discarded SNs with bits set to ‘1’ and non-discarded SNs with bits set to ‘0’. This provides a detailed representation of the discarded SNs within a particular range. For example, if the first device 504 has discarded SNs 3 and 5 within a sequence of SNs from 1 to 6, the FDC field may be set to ‘3’, and the discard bitmap may be ‘101000’, indicating that SNs 3 and 5 are discarded while SNs 1, 2, 4, and 6 are not.

The first device 504 may construct the PDCP gap report following standard formats or may include enhancements introduced by the invention to improve efficiency or compatibility.

Transmitting the PDCP gap report may be performed prior to initiation of a reordering timer at the second device 502 associated with the at least one SN. By sending the PDCP gap report before the reordering timer starts, the first device 504 may accordingly prevent unnecessary delays in data delivery. Receiving the PDCP gap report allows the second device 502 to update its receive window sooner, bypassing the need to wait for the timer to expire and improving responsiveness.

At step 512, the second device 502 may process the received PDCP gap report. Upon receiving the PDCP gap report, the second device 502 may consider each PDCP SDU indicated in the gap report (e.g., each SDU with a bit set to ‘1’ in the discard bitmap, or with a COUNT value equal to the FDC field) as discarded. The second device 502 may then update its receive window state variables accordingly. If RX_DELIV is less than or equal to the largest COUNT value associated with the discarded SDUs, the second device 502 may update RX_NEXT if the current RX_NEXT is less than or equal to the COUNT value associated with the last discarded SDU indicated in the gap report. If RX_DELIV is equal to any COUNT value associated with the discarded SDUs, the second device 502 may deliver to upper layers all stored PDCP SDUs with consecutively associated COUNT values starting from COUNT=RX_DELIV+1, where consecutively associated COUNT values include both stored SDUs and SDUs considered as discarded. The second device 502 may then update RX_DELIV to the COUNT value of the first PDCP SDU that has not been delivered to upper layers and is not considered as discarded. If the t-Reordering timer is running and RX_DELIV is greater than or equal to RX_REORD, the second device 502 may stop and reset the t-Reordering timer. If the t-Reordering timer is not running and RX_DELIV is less than RX_NEXT, the second device 502 may start the t-Reordering timer. By processing the PDCP gap report in this manner, the second device 502 may promptly advance its receive window and deliver buffered SDUs to upper layers without waiting for the t-Reordering timer to expire, thereby reducing latency for the end user.

The generic PDCP SN Gap Report initiation procedure described with respect to FIG. 5 provides several advantages over existing approaches. By defining multiple trigger conditions, the procedure enables the transmitting PDCP entity to notify the receiving PDCP entity of discarded SNs under a wide range of scenarios, including scenarios arising from standards-defined procedures (e.g., PDCP re-establishment, PDCP data recovery, PDCP status reporting) as well as implementation-specific procedures (e.g., memory management, traffic prioritization, machine learning-based optimization). The generic procedure is also extensible to future network procedures and configurations, as new trigger conditions can be defined without modifying the fundamental gap report mechanism. Furthermore, the generic procedure may be beneficial in multi-vendor deployments where interoperability issues between different vendor implementations may lead to unexpected PDCP SN gaps. By providing a robust mechanism for the transmitter to proactively report discarded SNs, the generic procedure helps maintain synchronization between PDCP entities across diverse network configurations and operational conditions, ultimately reducing unnecessary t-Reordering delays and improving the user experience for latency-sensitive applications.

In one example, FIG. 5 may further illustrate a handover scenario involving a UE (e.g., first device 504), a source RAN node, and a target RAN node, in which a PDCP SN Gap Report is lost during handover and retransmitted during PDCP re-establishment. In this scenario, the first device 504 transmits PDCP SDUs to the source RAN node over a DRB mapped on RLC AM, and all PDCP SDUs before SDU #X are successfully delivered. The transmitting PDCP entity at the first device 504 then discards SDU #X (e.g., due to expiry of the discardTimer) and triggers a PDCP SN Gap Report. The PDCP SN Gap Report and SDUs from SDU #(X+1) onwards are submitted to the RLC layer for transmission. Before the RLC layer successfully delivers the PDCP SN Gap Report or any of the pending SDUs, the first device 504 receives an RRC command for handover from the source RAN node to the target RAN node. The handover command triggers RLC re-establishment for the DRB, which flushes the RLC transmission buffer, causing the PDCP SN Gap Report and pending PDCP Data PDUs to be lost. The source RAN node sends an XnAP SN Status Transfer to the target RAN node, indicating SDU #X as the first missing UL SDU.

After handover completion, the first device 504 performs PDCP re-establishment. As part of the PDCP re-establishment, the transmitting PDCP entity at the first device 504 determines that a previously transmitted PDCP SN Gap Report has not been confirmed as successfully delivered by lower layers. The transmitting PDCP entity re-submits the PDCP SN Gap Report to lower layers for transmission to the target RAN node (e.g., second device 502). The first device 504 also retransmits SDUs from SDU #(X+1) onwards to the target RAN node as part of the PDCP re-establishment procedure. The target RAN node receives the retransmitted PDCP SN Gap Report and processes it by considering SDU #X as discarded, updating RX_DELIV and RX_NEXT accordingly, and delivering any buffered SDUs to upper layers without activating the t-Reordering timer for the discarded SDU. By retransmitting the PDCP SN Gap Report during PDCP re-establishment, the first device 504 ensures that the target RAN node is informed of the discarded SDU, thereby avoiding unnecessary t-Reordering delays that would otherwise degrade the user experience for latency-sensitive applications.

### Example Operations

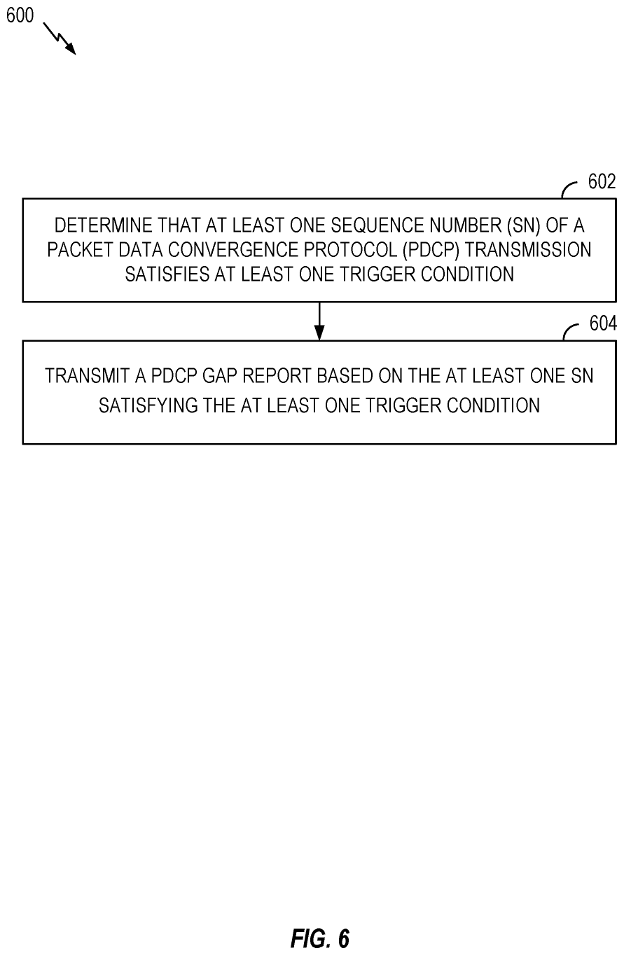

FIG. 6 shows a method 600 for wireless communications by a device, such as UE 104 of FIGS. 1 and 3, BS 102 of FIGS. 1 and 3, a disaggregated base station as discussed with respect to FIG. 2, or a combination thereof.

Method 600 begins at step 610 with determining that at least one sequence number (SN) of a packet data convergence protocol (PDCP) transmission satisfies at least one trigger condition.

Method 600 then proceeds to step 620 with transmitting a PDCP gap report based on the at least one SN satisfying the at least one trigger condition.

In one aspect, method 600 includes determining that the at least one SN has been discarded.

In one aspect, method 600 further includes determining that a PDCP status report requesting retransmission of the at least one SN has been received.

In one aspect, method 600 further includes determining that an acknowledgment for the at least one SN has not been received from a network interface within a predetermined time period.

In one aspect, determining that the at least one SN has been discarded includes determining that the at least one SN has been discarded due to exceeding a delay budget associated with scheduling by a Radio Link Control (RLC) entity.

In one aspect, determining that the at least one SN has been discarded includes determining that the at least one SN has been discarded due to one or more operational constraints.

In one aspect, the one or more operational constraints include at least one of: memory overflow, computational resource constraints, packet prioritization, proprietary procedures, machine learning inferences, or a combination thereof.

In one aspect, determining that the at least one SN has been discarded includes determining that the at least one SN has been discarded due to packet loss on a network interface between network entities.

In one aspect, method 600 further includes determining the PDCP gap report to include an indication of the at least one SN.

In one aspect, the indication of the at least one SN includes at least one of: a first discarded COUNT (FDC) field set to a smallest value of the at least one SN; a discard bitmap indicating the at least one SN; or a combination thereof.

In one aspect, the method is performed by a transmitter located in at least one of: a user equipment (UE), a network node, or a combination thereof.

In one aspect, transmitting the PDCP gap report is performed prior to initiation of a reordering timer at a receiver associated with the at least one SN.

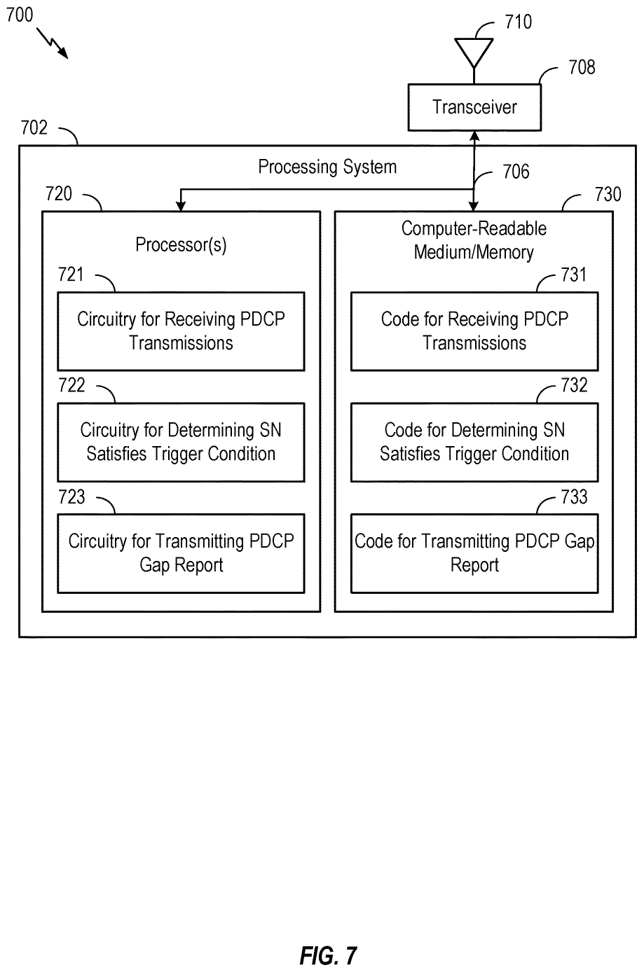

In one aspect, method 600, or any aspect related to it, may be performed by an apparatus, such as communications device 700 of FIG. 7, which includes various components operable, configured, or adapted to perform method 600. Communications device 700 is described below in further detail.

Note that FIG. 6 is just one example of a method, and other methods including fewer, additional, or alternative steps are possible consistent with this disclosure.

### Example Communications Devices

FIG. 7 depicts aspects of an example communications device 700. In some aspects, communications device 700 is a user equipment, such as UE 104 described above with respect to FIGS. 1 and 3. In additional or alternative aspects, communications device 700 is a network entity, such as BS 102 of FIGS. 1 and 3, a disaggregated base station as discussed with respect to FIG. 2, or a combination thereof. The communications device 700 includes a processing system 702 coupled to a transceiver 708 (e.g., a transmitter and/or a receiver). The transceiver 708 is configured to transmit and receive signals for the communications device 700 via an antenna 710, such as the various signals as described herein. The processing system 702 may be configured to perform processing functions for the communications device 700, including processing signals received and/or to be transmitted by the communications device 700. The processing system 702 includes one or more processors 720. In various aspects, the one or more processors 720 may be representative of one or more of receive processor 358, transmit processor 364, TX MIMO processor 366, and/or controller/processor 380, as described with respect to FIG. 3. The one or more processors 720 are coupled to a computer-readable medium/memory 730 via a bus 706. In certain aspects, the computer-readable medium/memory 730 is configured to store instructions (e.g., computer-executable code) that when executed by the one or more processors 720, cause the one or more processors 720 to perform the method 600 described with respect to FIG. 6, or any aspect related to it. Note that reference to a processor performing a function of communications device 700 may include one or more processors performing that function of communications device 700. In the depicted example, computer-readable medium/memory 730 stores code (e.g., executable instructions) for receiving PDCP transmissions 731, code for determining that SN satisfies trigger condition 732, and code for transmitting PDCP gap reports 733. Processing of the code 731-733 may cause the communications device 700 to perform the method 600 described with respect to FIG. 6, or any aspect related to it. The one or more processors 720 include circuitry configured to implement (e.g., execute) the code stored in the computer-readable medium/memory 730, including circuitry for receiving PDCP transmissions 721, circuitry for determining that SN satisfies trigger condition 722, and circuitry for transmitting PDCP gap reports 723. Processing with circuitry 721-723 may cause the communications device 700 to perform the method 600 described with respect to FIG. 6, or any aspect related to it. Various components of the communications device 700 may provide means for performing the method 600 described with respect to FIG. 6, or any aspect related to it. For example, means for transmitting, sending, or outputting for transmission may include the transceivers 354 and/or antenna(s) 352 of the UE 104 illustrated in FIG. 3 and/or transceiver 708 and antenna 710 of the communications device 700 in FIG. 7. Means for receiving or obtaining may include the transceivers 354 and/or antenna(s) 352 of the UE 104 illustrated in FIG. 3 and/or transceiver 708 and antenna 710 of the communications device 700 in FIG. 7.

### Example Clauses

Implementation examples are described in the following numbered clauses:
Clause 1: A system comprising a processor; and a memory storing instructions which, when executed by the processor, cause the processor to: determine that at least one sequence number (SN) of a packet data convergence protocol (PDCP) transmission satisfies at least one trigger condition; and transmit a PDCP gap report based on the at least one SN satisfying the at least one trigger condition.
Clause 2: The system of clause 1, wherein the instructions, when executed by the processor to determine that the at least one SN satisfies the at least one trigger condition, further cause the processor to determine that the at least one SN has been discarded.
Clause 3: The system of clause 2, wherein the instructions, when executed by the processor to determine that the at least one SN satisfies the at least one trigger condition, further cause the processor to determine that a PDCP status report requesting retransmission of the at least one SN has been received after the at least one SN has been discarded.
Clause 4: The system of clause 2, wherein the instructions, when executed by the processor to determine that the at least one SN satisfies the at least one trigger condition, further cause the processor to determine that an acknowledgment for the at least one SN has been received and that the at least one SN has been discarded due to packet loss on a network interface.
Clause 5: The system of clause 2, wherein the instructions, when executed by the processor to determine that the at least one SN has been discarded, further cause the processor to determine that the at least one SN has been discarded due to exceeding a delay budget associated with scheduling by a Radio Link Control (RLC) entity.
Clause 6: The system of clause 2, wherein the instructions, when executed by the processor to determine that the at least one SN has been discarded, further cause the processor to determine that the at least one SN has been discarded due to one or more operational constraints.
Clause 7: The system of clause 6, wherein the one or more operational constraints comprise at least one of memory overflow, computational resource constraints, packet prioritization, proprietary procedures, machine learning inferences, or a combination thereof.
Clause 8: The system of clause 1, wherein the operations further cause the processor to determine the PDCP gap report to include an indication of the at least one SN.
Clause 9: The system of clause 8, wherein the indication of the at least one SN comprises at least one of a first discarded COUNT (FDC) field set to a smallest value of the at least one SN; a discard bitmap indicating the at least one SN; or a combination thereof.
Clause 10: The system of clause 1, wherein the system is located in at least one of a user equipment (UE), a network node, or a combination thereof.
Clause 11: The system of clause 1, wherein transmitting the PDCP gap report is performed prior to initiation of a reordering timer at a receiver associated with the at least one SN.
Clause 12: The system of clause 2, wherein the instructions, when executed by the processor to determine that the at least one SN has been discarded, further cause the processor to determine that the at least one SN has been discarded due to congestion handling based on one or more quality of service (QoS) parameters associated with the at least one SN.
Clause 13: The system of clause 1, wherein the instructions, when executed by the processor to determine that the at least one SN satisfies the at least one trigger condition, further cause the processor to determine that an acknowledgment for the at least one SN has not been received from a network interface within a predetermined time period.
Clause 14: The system of clause 1, wherein the instructions, when executed by the processor to determine that the at least one SN satisfies the at least one trigger condition, further cause the processor to determine that a PDCP status report has been received from a receiving entity comprising a COUNT value that is invalid with respect to a current state of the transmitting PDCP entity.
Clause 15: The system of clause 1, wherein the instructions, when executed by the processor, further cause the processor to: determine that a previously transmitted PDCP gap report associated with the at least one SN has not been confirmed as successfully delivered by a lower layer entity; and re-submit the PDCP gap report to the lower layer entity as part of a PDCP entity re-establishment procedure.
Clause 16: The system of clause 1, wherein the instructions, when executed by the processor, further cause the processor to: determine that the at least one SN has been proactively discarded based on an inference by a machine learning model predicting that the at least one SN is likely to experience a transmission delay exceeding a threshold.
Clause 17: A method comprising determining that at least one sequence number (SN) of a packet data convergence protocol (PDCP) transmission satisfies at least one trigger condition; and transmitting a PDCP gap report based on the at least one SN satisfying the at least one trigger condition.
Clause 18: The method of clause 17, wherein determining that the at least one SN satisfies the at least one trigger condition comprises determining that the at least one SN has been discarded.
Clause 19: The method of clause 18, wherein determining that the at least one SN satisfies the at least one trigger condition comprises determine that a PDCP status report requesting retransmission of the at least one SN has been received after the at least one SN has been discarded.
Clause 20: The method of clause 18, wherein determining that the at least one SN satisfies the at least one trigger condition further comprises determining that an acknowledgment for the at least one SN has been received and that the at least one SN has been discarded due to packet loss on a network interface.
Clause 21: The method of clause 18, wherein determining that the at least one SN has been discarded comprises determining that the at least one SN has been discarded due to one or more operational constraints.
Clause 22: The method of clause 21, wherein the one or more operational constraints comprise at least one of memory overflow, computational resource constraints, packet prioritization, proprietary procedures, machine learning inferences, or a combination thereof.
Clause 23: The method of clause 17, further comprising determining the PDCP gap report to include an indication of the at least one SN.
Clause 24: The method of clause 17, wherein transmitting the PDCP gap report is performed prior to initiation of a reordering timer at a receiver associated with the at least one SN.
Clause 25: The method of clause 18, wherein determining that the at least one SN has been discarded comprises determining that the at least one SN has been discarded due to exceeding a delay budget associated with scheduling by a Radio Link Control (RLC) entity.
Clause 26: A non-transitory, computer-readable medium storing instructions which, when executed by a processor, cause the processor to perform operations comprising determining that at least one sequence number (SN) of a packet data convergence protocol (PDCP) transmission satisfies at least one trigger condition; and transmitting a PDCP gap report based on the at least one SN satisfying the at least one trigger condition.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus, comprising:
one or more memories comprising instructions; and
one or more processors coupled with the one or more memories and individually or collectively operable to execute the instructions to cause the apparatus to:
determine that at least one sequence number (SN) of a packet data convergence protocol (PDCP) transmission satisfies at least one trigger condition; and
transmit a PDCP gap report based on the at least one SN satisfying the at least one trigger condition.

2. The apparatus of claim 1, wherein, to determine that the at least one SN satisfies the at least one trigger condition, the instructions further cause the apparatus to:
determine that a PDCP status report requesting retransmission of the at least one SN has been received after the at least one SN has been discarded.

3. The apparatus of claim 1, wherein, to determine that the at least one SN satisfies the at least one trigger condition, the instructions further cause the apparatus to:
determine that an acknowledgment for the at least one SN has been received and that the at least one SN has been discarded due to packet loss on a network interface.

4. The apparatus of claim 1, the instructions further cause the apparatus to:
determine that the at least one SN has been discarded due to exceeding a delay budget associated with scheduling by a Radio Link Control (RLC) entity.

5. The apparatus of claim 1, the instructions further cause the apparatus to:
determine that the at least one SN has been discarded due to one or more operational constraints.

6. The apparatus of claim 5, wherein the one or more operational constraints comprise at least one of memory overflow, computational resource constraints, packet prioritization, proprietary procedures, machine learning inferences, or a combination thereof.

7. The apparatus of claim 1, wherein the instructions further cause the apparatus to:
determine the PDCP gap report to include an indication of the at least one SN.

8. The apparatus of claim 7, wherein the indication of the at least one SN comprises at least one of:
a first discarded COUNT (FDC) field set to a smallest value of the at least one SN;
a discard bitmap indicating the at least one SN; or
a combination thereof.

9. The apparatus of claim 1, the instructions further cause the apparatus to:
determine that the at least one SN has been discarded due to congestion handling based on one or more quality of service (QoS) parameters associated with the at least one SN.

10. The apparatus of claim 1, wherein transmitting the PDCP gap report is performed prior to initiation of a reordering timer at a receiver associated with the at least one SN.

11. The apparatus of claim 1, wherein, to determine that the at least one SN satisfies the at least one trigger condition, the instructions further cause the apparatus to:
determine that an acknowledgment for the at least one SN has not been received from a network interface within a predetermined time period.

12. The apparatus of claim 1, wherein, to determine that the at least one SN satisfies the at least one trigger condition, the instructions further cause the apparatus to:
determine that a PDCP status report has been received from a receiving entity comprising a COUNT value that is invalid with respect to a current state of the transmitting PDCP entity.

13. The apparatus of claim 1, the instructions further cause the apparatus to:
determine that a previously transmitted PDCP gap report associated with the at least one SN has not been confirmed as successfully delivered by a lower layer entity; and re-submit the PDCP gap report to the lower layer entity as part of a PDCP entity re-establishment procedure.

14. The apparatus of claim 1, the instructions further cause the apparatus to:
determine that the at least one SN has been proactively discarded based on an inference by a machine learning model predicting that the at least one SN is likely to experience a transmission delay exceeding a threshold.

15. A method, comprising:
determine that at least one sequence number (SN) of a packet data convergence protocol (PDCP) transmission satisfies at least one trigger condition; and
transmit a PDCP gap report based on the at least one SN satisfying the at least one trigger condition.

16. The method of claim 15, wherein determining that the at least one SN satisfies the at least one trigger condition, the method further comprises:
determining that a PDCP status report requesting retransmission of the at least one SN has been received after the at least one SN has been discarded.

17. The method of claim 15, wherein, determining that the at least one SN satisfies the at least one trigger condition, the method further comprises:
determining that an acknowledgment for the at least one SN has been received and that the at least one SN has been discarded due to packet loss on a network interface.

18. The method of claim 15, further comprising:
determine that the at least one SN has been discarded due to exceeding a delay budget associated with scheduling by a Radio Link Control (RLC) entity.

19. A non-transitory computer-readable medium storing instructions that, when executed by one or more processors, cause the one or more processors to perform operations comprising:
determining that at least one sequence number (SN) of a packet data convergence protocol (PDCP) transmission satisfies at least one trigger condition; and
transmitting a PDCP gap report based on the at least one SN satisfying the at least one trigger condition.

20. The non-transitory computer-readable medium apparatus of claim 19, wherein, to determine that the at least one SN satisfies the at least one trigger condition, the operations comprise:
determining that a PDCP status report requesting retransmission of the at least one SN has been received after the at least one SN has been discarded.
